(19) United States
(12) Patent Application Publication
(10) Pub. No.: US 2004/0233807 A1
(43) Pub. Date: Nov. 25, 2004

(54) Apparatus and method for connecting interrupted recording

(75) Inventors: Wen-Yi Wu, Hsin-Chu City (TW); Hong-Ching Chen, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/843,314

(22) Filed: May 12, 2004

(30) Foreign Application Priority Data
May 21, 2003 (TW) 092113776

(51) Int. Cl. G11B 5/09

(52) U.S. Cl. 369/47.32

(57) ABSTRACT

An optical recording device records data on an optical storage medium. The device generates a data-interrupted address and reconnects the interrupted data from a data-reconnecting address so as to enable further correct reading of the interrupted data. The device comprises an addressing module for providing a reference address on the storage medium as a reference address; a recording-interrupted generator for detecting a recording-interrupted condition and generating a recording-interrupted signal; a data recording module for recording and suspending recording the data according to the recording-interrupted signal, and reconnecting the data according to a data-reconnecting address and the reference address; a data-interrupted address generator for generating the data-interrupted address; a data-reconnecting address generator for generating the data-reconnecting address.

### BACKGROUND OF THE INVENTION

1. Field of the invention

The present invention relates to an optical recording device for recording a plurality of data on an optical storage medium, more particularly, the present invention relates to an optical recording device for reconnecting the interrupted data from a data-reconnecting address.

2. Description of the prior art

When conventional optical recording devices (for example, CD recorders or DVD recorders) record a plurality of data on optical storage mediums (for example, CD, VCD, and DVD discs), sometimes recording interruptions are caused by some factors, and then the data cannot be correctly recorded on the optical storage mediums. These factors causing the recording interruption comprise: the shocks of the recorder or wrong tracking of the optical pickup head of the recorder.

The prior art (for example, the U.S. Pat. No. 6198707) takes the logical address when recording is interrupted as a data-interrupted address, and further suspends the input data to be recorded on the disc in the interrupted location. Then, it reconnects the suspended input data on the disc starting from the data-interrupted address.

The prior art (for example, the U.S. patent application Ser. No. 10/639808) takes the physical address when recording is interrupted as a data-interrupted address, and decides a data-reconnecting physical address as the location for reconnecting data. The data-reconnecting physical address can be the data-interrupted address or the address added/subtracted an offset value to the data-interrupted address. Then, the U.S. patent application Ser. NO. 10/639808 starts reconnecting the suspended input data on the disc.

However, in the prior arts, because there is a delay between the suspended location of the input data when recording is interrupted and the logical or physical address of the interruption of data actually recorded on the disc; the prior arts do not adjust the reconnecting input data according to the logical or physical address of the interruption of data actually recorded on the disc, which makes that the data portion between the reconnecting data and the data actually recorded on the disc is lost, and further makes the data recorded on the disc unable to be read correctly.

As the recording/reading speed of the present optical recording devices become faster and faster, the probability of the recording interruptions becomes higher. Therefore, it is very important to reduce the errors when reconnecting the interrupted data, so as to make the reconnected data to be read correctly later.

Therefore, the main objective of the present invention is to provide a method for reconnecting the interrupted data when a recording interruption occurs in the optical recording devices, so as to solve the above-mentioned problems.

### SUMMARY OF THE INVENTION

The main objective of the present invention is to provide an optical recording device and the method thereof for recording a plurality of digital data on an optical storage medium.

Another objective of the present invention is to provide an optical recording device and the method thereof for generating a data-interrupted address when recording is interrupted, and then continuing to reconnect the interrupted data from a data-reconnecting address so as to enable further correct reading of the interrupted data.

According to an embodiment of the present invention, the optical recording device comprises a recording-interrupted generator, a data recording module, the data-interrupted address generator, and a data-reconnecting address generator. When detecting an interruption during recording data, the recording-interrupted generator detects a recording-interrupted condition, and correspondingly generates a recording-interrupted signal. Then the data recording module suspends recording the data on the optical storage medium when receiving the recording-interrupted signal. The data-interrupted address generator is used for generating the data-interrupted address. The data-reconnecting address generator is used for generating the data-reconnecting address according to the data-interrupted address. According to the data-reconnecting address, the data recording module adjusts the data to be fuirther recorded according to the data-reconnecting address, and takes the data-reconnecting address as the starting address when reconnecting the data on the optical storage medium.

With the present invention, the problems in the prior arts can be solved, such as: some data are lost after data reconnection because the data can not be adjusted for further recording. Because the present invention can correctly reconnect interrupted data on the optical recording medium, the present invention further reduces the rerecording time, and decreases the wasted cost of discs.

The advantage and spirit of the invention may be understood by the following recitations together with the appended drawings.

### BRIEF DESCRIPTION OF THE APPENDED DRAWINGS

FIG. 1 is a schematic diagram of the data format of a data sector on a DVD disc.

FIG. 2 is a system block diagram of the optical recording device of the present invention.

FIG. 3 is a schematic diagram of an addressing module, which is a physical addressing module, shown in FIG. 2 according to an embodiment.

FIG. 4 is a schematic diagram of an addressing module, which is a physical addressing module, shown in FIG. 2 according to another embodiment.

FIG. 5 is a schematic diagram of an addressing module, which is a physical addressing module, shown in FIG. 2 according to another embodiment.

FIG. 6 is a schematic diagram of an addressing module, which is a logical addressing module, shown in FIG. 2 according to another embodiment.

FIG. 7 is a system block diagram of the logical address counter shown in FIG. 6.

FIG. 8 is a schematic diagram of the data-interrupted address generator shown in FIG. 2.

FIG. 9 is a schematic diagram of the relation between the actual interrupted point and the interrupted signal.

FIG. 10 is a system block diagram of the data-reconnecting address generator according to the embodiment of the present invention.

FIG. 11 is a schematic diagram for data reconnection while the optical storage medium is a rewritable disc.

FIG. 12 is a schematic diagram when adjusting the data to be further recorded, according to the embodiment shown in FIG. 11.

FIG. 13 is a schematic diagram for data reconnection while the optical storage medium is an un-rewritable disc.

### DETAILED DESCRIPTION OF THE INVENTION

The principle of conventional recording discs (for example: CD-R/RW, DVD+R/RW, and DVD−R/RW) is to record digital data on a spiral pre-groove track in the discs. The pre-groove track is a slight wobbling one, and the wobble frequency can be used to control the recording speed. In the following paragraphs, DVD disc is taken as an example to explain the data format when data is recorded on the discs.

The data units of a DVD disc comprise the following four kinds: the channel bit, the data frame, the data sectors, and the ECC block. The channel bit is the smallest recording unit of the discs. Each data byte is modulated into 16 channel bits through an eight-to-fourteen-modulation plus (EFM+) modulation and is then recorded on the disc. The EFM+ modulation requires that the maximum length of the continuous channel bits with the identical signal state be not longer than 11 bits, and the minimum length of the continuous channel bits with the identical signal state be not shorter than 3 bits. A 32 bits data frame sync symbol is added every 1456 channel bits, and these total 1488 channel bits constitute a data frame. The data frame sync symbol comprises a continuous 14 bits identical signal state, so as to identify the data frame sync symbol from the channel bits of the normal EFM+ modulation. The detail data format of DVD discs is well known by the person skilled in this art. If it is necessary, please refer to the related DVD data book or the U.S. patent application Ser. No. 10/639808, and no redundant description is further made herein.

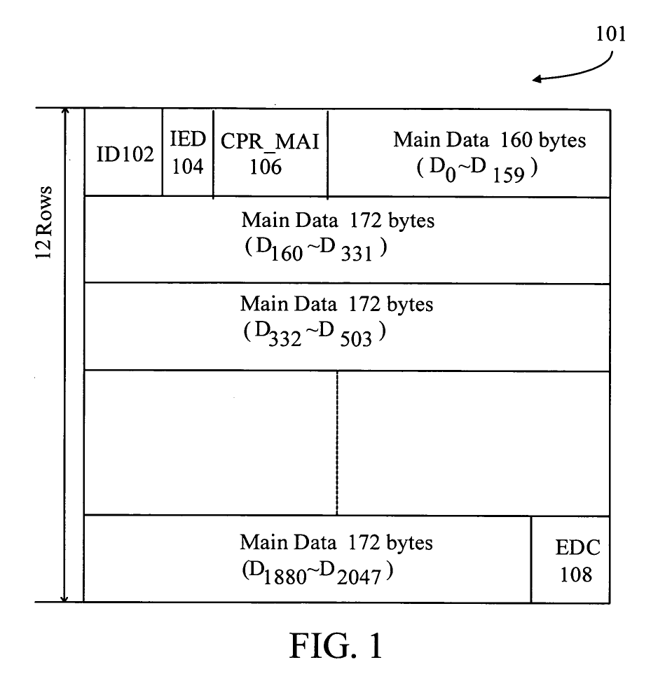

FIG. 1 is a schematic diagram of the data format of a data sector 101 on a DVD disc. Every 26 data frame forms a data sector 101. A data sector 101 is the smallest logical data unit of DVD discs that can be accessed. Each data sector 101 comprises an 4 bytes identification data (ID) 102, an 2 bytes ID error detection (IED) code 104, a 6 bytes copyright management information (CPR_MAI) 106, a 2048 bytes main data, and a 4 bytes error detection code (EDC) 108.

The ID 102 is in the front 4 bytes of the data sector 101 for storing the sector ID of the data sector 101. If there is data recorded on a disc, the sector ID of the data sector 101 and the sector sync code SYO can be used to allocate the address on discs, wherein the address is called the logical address of discs. The ID 102 and the IED code 104 co-forms to a 6 bits (6,4) Reed-Solomon code for detecting and correcting errors to the ID 102.

The EDC 108 is a 4 bytes cyclic redundancy checking code 104 used in the ID 102, the ID EDC 104, the CPR_MAI 106, and the main data for detecting errors of the data sector 101. Then a sequence of scramble bytes is generated according to the ID 102 of the data sector 101 for scrambling the data sector 101. Every 16 scrambled data sectors 101 forms an error correction code (ECC) block, and performs the ECC procedure. This is done by appending one row of the parity of outer code (PO Code) to each ECC-encoded data sectors, and by appending 10 bytes of the parity of inner code (PI Code) to each rows of the ECC-encoded data sectors 101. The PO code and the PI code are used to correct errors during disc reading.

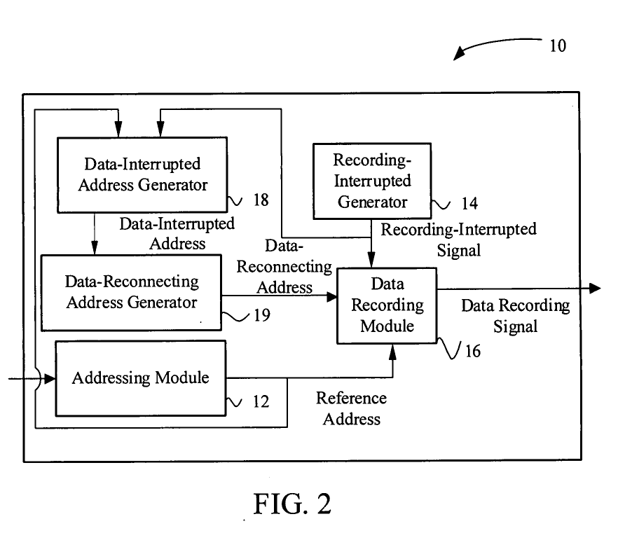

FIG. 2 is a system block diagram of the optical recording device 10 of the present invention. The optical recording device 10 is used for recording a plurality of data on an optical storage medium. The optical recording device 10 is a CD or DVD recorder. The optical storage medium can be chosen from various kinds of CD or DVD discs. The optical recording device 10 generates a data-interrupted address when recording is interrupted, and then continues to connect the interrupted data from a data-reconnecting address so as to enable further correct reading of the interrupted data.

The optical recording device 10 comprises an addressing module 12, a recording-interrupted generator 14, a data recording module 16, a data-interrupted address generator 18, and a data-reconnecting address generator 19.

The addressing module 12 is used for providing a reference address on the optical storage medium as a reference address during the data recording on the optical storage medium. The addressing module 12 according to the present invention can take various forms in different embodiments, such as a physical addressing module or a logical addressing module.

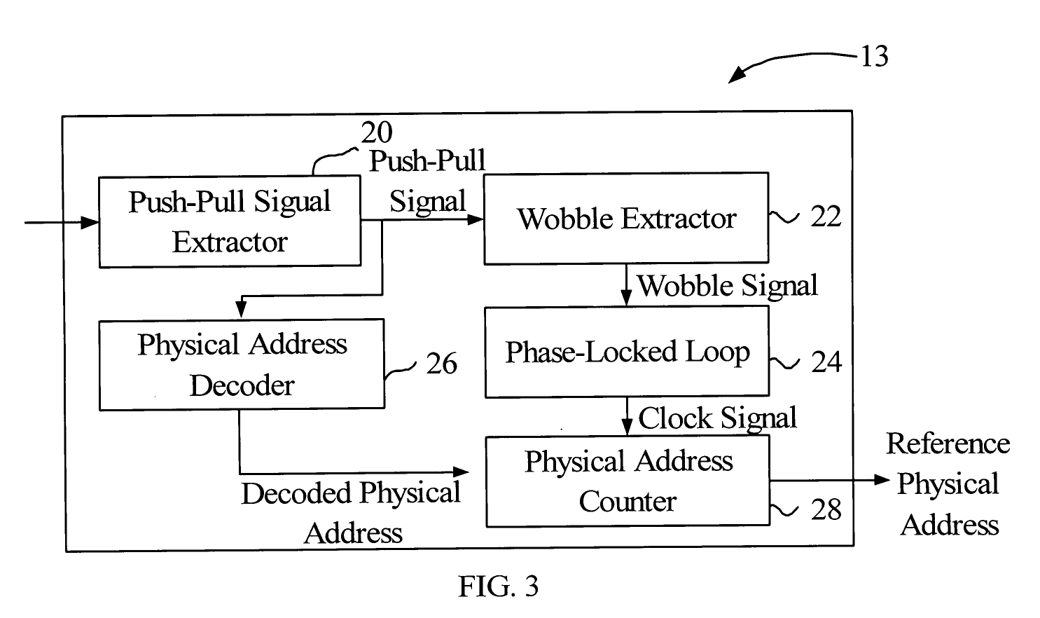

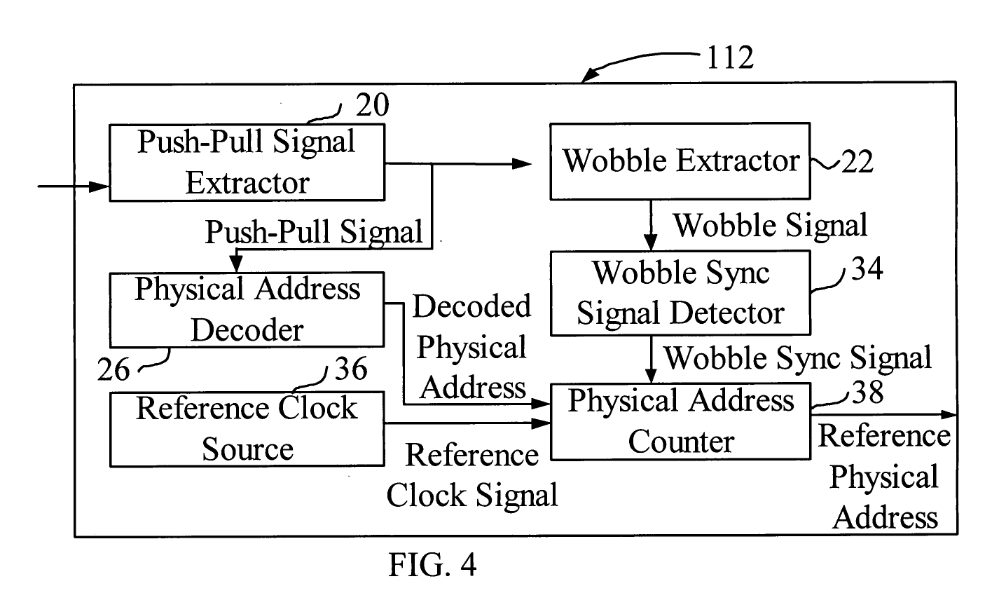

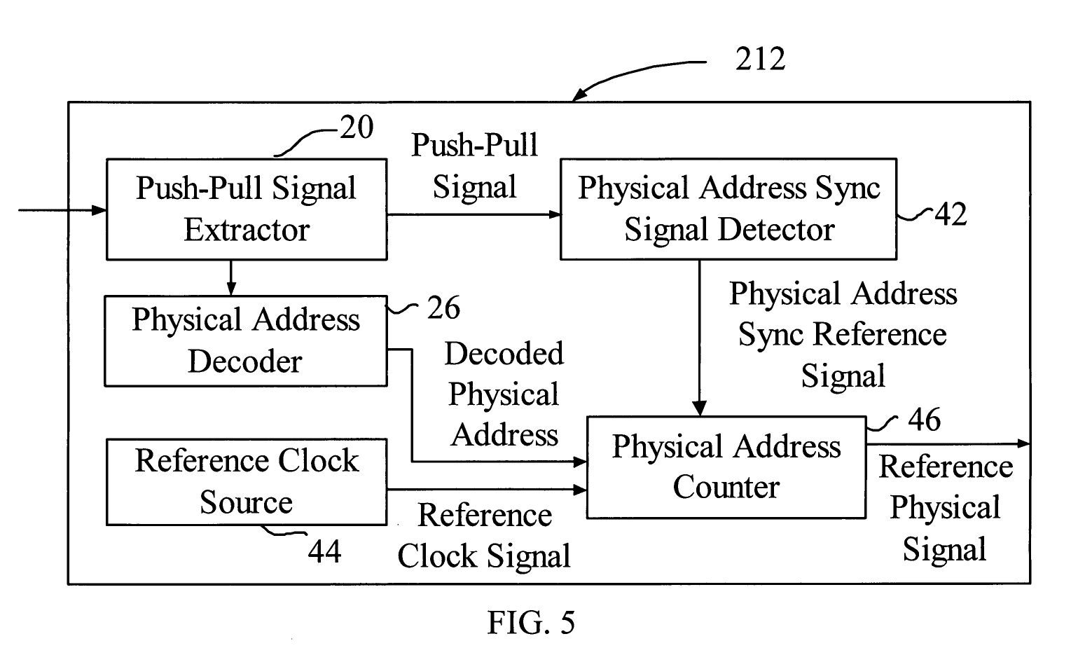

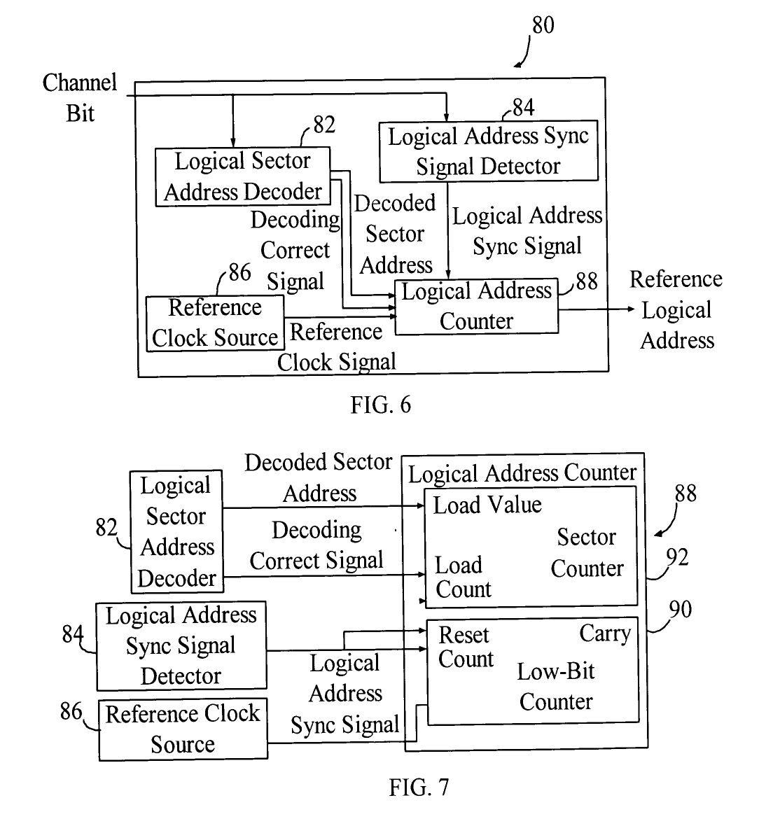

Please refer to FIG. 3, FIG. 4, FIG. 5, and FIG. 6. FIG. 3 is a schematic diagram of an addressing module 12 shown in FIG. 2, which is a physical addressing module 13. The physical addressing module 13 is used for providing a pre-recorded physical address on the optical storage medium as the reference address.

The physical addressing module 13 comprises a push-pull signal extractor 20, a wobble extractor 22, a phase-locked loop 24, a physical address decoder 26, and a physical address counter 28. When a photo detector of the optical recording device 10 reads data from the optical storage medium, two signals in both sides along the data track direction (or so called “tangential direction”) are read, and the push-pull signal extractor 20 extracts a push-pull signal by subtracting the two signals in both sides of the tangential direction. The wobble extractor 22 extracts a wobble signal in the predetermined groove on the optical storage medium from the push-pull signal, and sends the wobble signal to the phase-locked loop 24. Then the phase-looked loop 24 generates a clock signal synchronized with the wobble signal, and further sends the clock signal to the physical address counter 28 for counting. The physical address decoder 26 is used to decode the push-pull signal for obtaining a physical address on the optical storage medium corresponding to the push-pull signal, which is sent to the physical address counter 28. The physical address counter 28 receives the physical address from the physical address decoder 26 and the clock signal from the phase-locked loop 24. When the physical address decoder 26 correctly decodes a physical address, the physical address counter 28 is loaded with an address value corresponding to the decoded physical address. Then the physical address counter 28 counts according to the clock signal of the phase-locked loop 24, so as to generate the reference physical address. The reference physical address is an address with more precise resolution than the physical address decoded by the physical address decoder 26. And it is then sent to the data recording module 16 as a reference address for recording data on the optical storage medium. Therefore, the reference address with more precise resolution can be provided by the reference physical address.

FIG. 4 is a schematic diagram of an addressing module 12, which is here a physical addressing module 112, shown in FIG. 2 according to another embodiment of the present invention. The physical addressing module 112 comprises a push-pull signal extractor 20, a wobble extractor 22, a wobble sync signal detector 34, a physical address decoder 26, a reference clock source 36, and a physical address counter 38. The push-pull signal extractor 20, the wobble extractor 22, and the physical address decoder 26 are the same devices as shown in the physical addressing module 13 in FIG. 3. Instead of using the phase-locked loop 24 in FIG. 3, the wobble sync signal detector 34 is employed in this embodiment to lock the wobble signal. The phase of the output signal is adjusted with the unit of one period of the reference clock source 36 so as to generate the wobble sync signal. Besides, the counting method of the physical address counter 38 is somewhat different from that of the physical address counter 28.

FIG. 5 is a schematic diagram of an addressing module 12, which is here a physical addressing module 212, shown in FIG. 2 according to another embodiment of the present invention. The physical addressing module 212 comprises a push-pull signal extractor 20, a physical address decoder 26, a physical address sync signal detector 42, a reference clock source 44, and a physical address counter 46. The difference between the physical addressing module 212 and the previous two embodiments is mainly the physical address sync signal detector 42. The physical address sync detector 42 detects a physical address sync signal pre-recorded on the optical storage medium from the push-pull signal, and generates a physical address sync reference signal. In a practical application, one embodiment of the physical address sync signal detector 42 can be a phase-clocked loop for locking the physical address sync signal and the phase of an output signal is adjusted with the unit of one period of the reference clock signal. The input clock signal of the physical address sync signal detector 42 not only can be the reference clock signal provided by the reference clock source 44, but also can be a high frequency clock signal provided by the other signal source.

As to the detail signal sequence of the physical addressing module 13, 112, and 212 and the counting method, the U.S. patent application Ser. No. 10/693808 can be taken as a reference. The following specification will focus more on the description of how the logical address is positioned or obtained.

FIG. 6 is a schematic diagram of an addressing module 12, which is here a logical addressing module 80, shown in FIG. 2 according to another embodiment of the present invention. The logical addressing module 80 is used for providing a reference logical address of the recorded data on the optical storage medium as the reference address.

The logical addressing module 80 comprises a logical sector address decoder 82, a logical address sync signal detector 84, a reference clock source 86, and a logical address counter 88. The logical sector address decoder 82 is used for decoding the logical sector address of a data recorded on the optical storage medium. The logical address sync signal detector 84 is used for detecting a logical address sync signal of the data. The reference clock source 86 is used for providing a reference clock signal.

FIG. 7 is a system block diagram of the logical address counter 88 shown in FIG. 5. The logical address counter comprises at least a low-bit counter 90 and a sector counter 92. The low-bit counter 90 performs counting according to the reference clock. signal. The logical address counter 88 is loaded with an address value corresponding to the decoded logical address when the logical sector address is correctly decoded. The logical address sync signal is used to increase the sector counter 92 and to reset the low-bit counter 90, to generate the reference address.

The DVD disc format is taken in the following as an example to describe the operation of the logical addressing module 80. The logical address sync signal is generated by detecting the sector sync code (SY0) of the data, and the decoded logical sector address is the ID 102. The reference clock frequency can be set to equal to the channel bit frequency, thus a sector sync code SYO is detected to generate a logical address sync signal for receiving 26 data frames (totally 1488*26 channel bits) of data. When the logical address sync signal is generated, the low-bit counter 90 is reset.

The logical sector address decoder 82 reads the ID 102 and the IED 104 of the data sector 101 on the optical storage medium, and performs error detecting and correcting on the (6,4) Reed-Solomon code co-formed by the ID 102 and the IED code 104. When detecting that the ID 102 has no error or has errors that can be corrected, the logical sector address decoder 82 sends out a high-level decoding correct signal, and sends out the sector ID of the data sector 101 from the corrected ID 102 as a decoding sector address.When the logical address sync signal is generated or occurs, the actual address would be the next sector of the decoding sector address, which is due to latency of the decoding action of the logical sector address. Therefore, the value to be loaded into the sector counter 92 would be the correct decoded sector address plus 1. When the logical address sync signal is generated or occurs and the decoding correct signal is in low-level, which means the logical sector address decoding value is incorrect, the sector counter 92 will increase one according to the previous value of the sector counter.

The reference location obtained by the physical addressing module 13, 112, 212 and the logical addressing module 80, is used as the reference address for addressing in the recording-interrupted generator 14, the data recording module 16, the data-interrupted address generator 18, and the data-reconnecting address generator 19.

The recording-interrupted generator 14 is used for detecting a recording-interrupted condition, and correspondingly generating a recording-interrupted signal. The aforementioned recording-interrupted condition is usually the condition leading to erroneous recording of the optical recording device 10. The recording-interrupted generator 14 also comprises a determination unit (not shown) for detecting the recording-interrupted condition and generating the recording-interrupted signal.

The data recording module 16 is used for recording the data on the optical storage medium, and suspending recording the data on the optical storage medium when receiving the recording-interrupted signal. The data recording module 16 further comprises a buffer memory (not shown) for buffering the data that are received from a data source but have not yet been recorded on the optical storage medium.

One of the recording-interrupted conditions for the recording-interrupted generator 14 is that the amount of data buffered in the buffer memory of the data recording module 16 is lower than a predetermined threshold value. Then before the amount of data buffered in the buffer memory decreases to none, the recording-interrupted generator 14 generates and sends the recording-interrupted signal to the data recording module 16 and the data-interrupted address generator 18. In addition, the situations of the shocks of the recorder or when the optical pickup head of a recorder is located on a wrong track would also give rise to the recording-interrupted conditions.

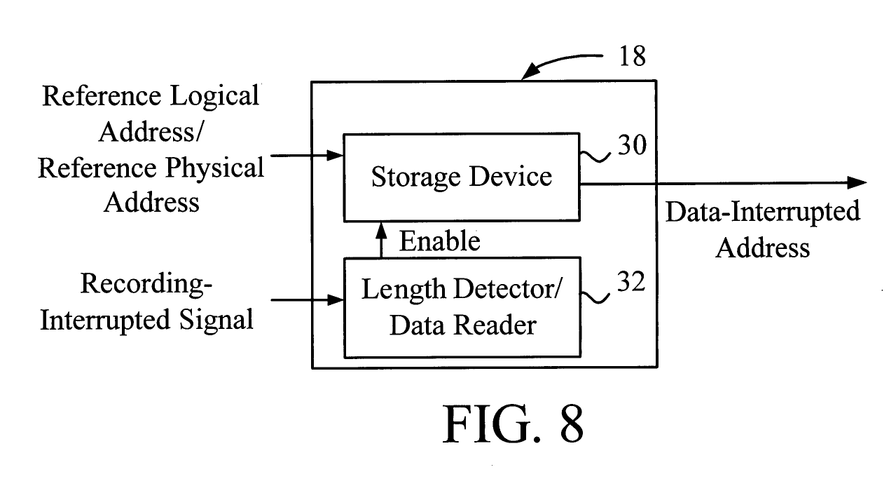

FIG. 8 is a schematic diagram of the data-interrupted address generator 18 shown in FIG. 2. The data-interrupted address generator 18 is used for generating the data-interrupted address after data recording is interrupted. The data-interrupted address generator 18 comprises a storage device 30 and a length detector/data reader 32. The data-interrupted address generator 18 connects between the recording-interrupted generator 14 and the addressing module 12.

When the data-interrupted address generator 18 receives the recording-interrupted signal sent from the recording-interrupted generator 14, the length detector/data reader 32 is employed for detecting the actual interrupted point. If the length detector 32 is built in the data-interrupted address generator 18, the length detector 32 receives the channel bit signal recorded on the optical storage medium and detects if the length of continuous channel bits with identical signal state exceeds a maximum allowable value. If yes, the length detector 32 generates an enable signal to the storage device 30. The enable signal represents the actual interrupted point. At this time, the storage device 30 stores a reference logical address or reference physical address, which corresponds to the actual interrupted point on the storage device 30. The reference logical or physical address stored on the storage device 30 is the data-interrupted address corresponding to the present data-interrupted location. For the detail operation of the length detector 32, please refer to the U.S. patent application Ser. No. 10/639808, and no redundant description is further made in this specification.

When the optical recording device 10 comprises the logical addressing module 80, the data reader 32 can be accommodated in the data-interrupted address generator 18. The data reader 32 first reads the data recorded on the optical storage medium before interrupt occurs, so as to detect whether an error amount of the data content is greater than a predetermined threshold value. The aforementioned error amount may come from an error detection code (EDC) or an error correction code (ECC) corresponding to the data.

Take a data sector 101 in FIG. 1 for an example. In the DVD specification, the ECC-encoded data sector 101 comprises 12 rows of data. Each row of data that is composed by two data frames is called an error correcting row. Each error correcting row comprises 10 bytes of the PI parity for correcting errors. When the error amount in an error correcting row exceeds the maximum correctable amount by the PI parity, the error correcting row would be detected as a PI no-solution. The error amount detected by the data reader 32 would be the amount of the error correcting rows detected as the PI no-solution in the logical data sector 101. If the amount of the error correcting rows of the PI no-solution is greater than the predetermined threshold value, the data reader 32 generates an enable signal to the storage device 30, so as to enable the storage device 30 to store the corresponding reference logical address as a data-interrupted logical address.

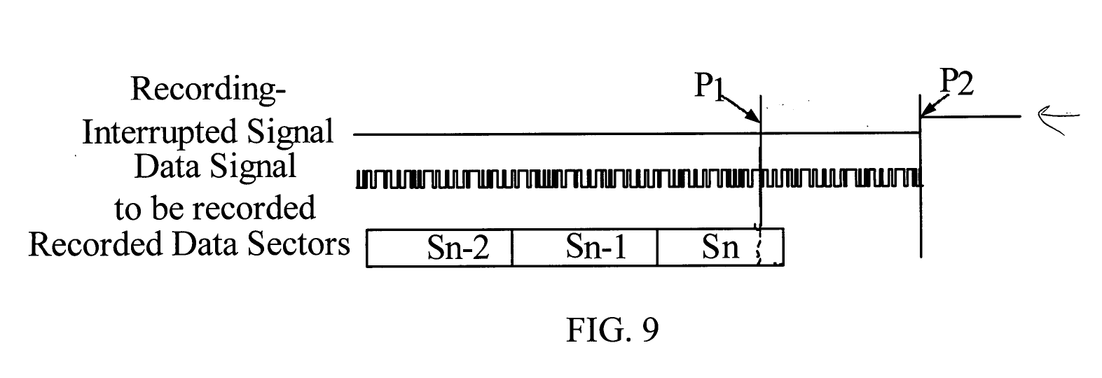

FIG. 9 is a schematic diagram of the relation between the actual interrupted point and the interrupted signal. P₁ represents the actual interrupted point and P₂ represents the occurring point of the recording-interrupted signal. When the data-interrupted address generator 18 receives the recording-interrupted signal, the data reader 32 forward reads the data sectors (Sₙ₋₂, Sₙ₋₁, and Sₙ) that have been recorded on the optical storage medium before data recording is interrupted. When detecting that the amount of the error correcting rows of the PI no-solution is large, the data reader 32 issues the enable signal and the corresponding reference logical address in the data sector (Sₙ) corresponding to P₁ is stored.

When a typical optical recording device is interrupted, there is a gap between P₁ and P₂. When data recording is interrupted in prior arts, the data to be further recorded cannot be adjusted and it merely pauses on the occurring or appearance time of the recording-interrupted signal that is the address of P₂. But the data recorded on the optical storage medium is actually interrupted in the address of P₁. Thus, even though prior arts can reconnect recording the later data, the problem associated with data lost between P₁ and P₂ still exists.

The data-interrupted address generator 18 sends the data-interrupted logical address to the data-reconnecting address generator 19. The data-reconnecting address generator 19 is used for generating the corresponding data-reconnecting address according to the data-interrupted address. In the embodiment of the present invention, the data-reconnecting address generator 19 adds/subtracts an offset value to the data-interrupted address as the data-reconnecting address. According to the embodiment of the present invention, when the present invention uses the logical address to be the reference address, the offset value comprises a difference between the logical address and the physical address.

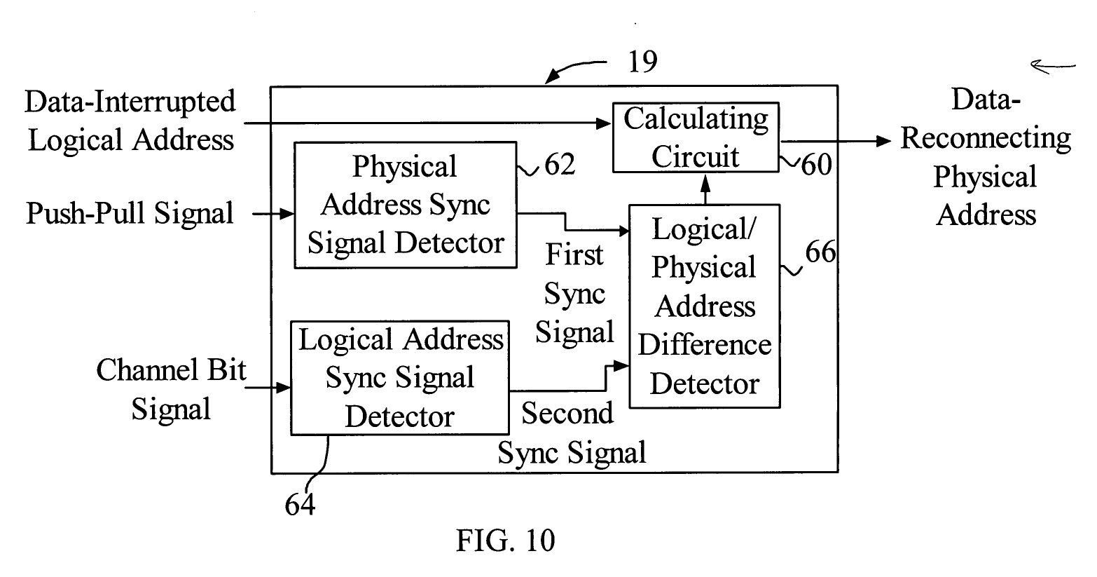

Please refer to FIG. 10. FIG. 10 is a system block diagram of the data-reconnecting address generator 19 according to the embodiment of the present invention. The data-reconnecting address generator 19 comprises a calculating circuit 60, a physical address sync signal detector 62, a logical address sync signal detector 64, and a logical/physical address difference detector 66. The physical address sync signal detector 62 detects a physical address sync signal pre-recorded on the optical storage medium from a push-pull signal, and generates a first sync signal synchronizing with the physical address. The logical address sync signal detector 64 detects the logical address sync signal of the recorded data on the optical storage medium, and generates a second sync signal synchronizing with the logical address. Taking the DVD-RW discs for example, the first sync signal can be a sync signal synchronized with the location of the pre-pit sync bit of the push-pull signal, and the second sync signal can be a sync signal synchronized with the location of the data frame sync symbol of the channel bit signal. The logical/physical address difference detector 66 is used for detecting the time period between the first sync signal and the second sync signal, and calculating the difference between the logical address and the physical address. Finally, according to the data-interrupted logical address generated by the data-interrupted address generator 18 and the previous-mentioned difference, the calculating circuit 60 generates a data-reconnecting physical address to the data recording module 16. The data recording module 16 takes the data-reconnecting physical address as a reference address, and reconnecting the interrupted data on the optical storage medium.

When the present invention reconnects the interrupted data according to the data-reconnecting address, the data recording module 16 adjusts the data to be further recorded as the data corresponding to the data-reconnecting address, takes the data-reconnecting address as the starting address to reconnect the data on the optical storage medium, and then reconnects the data on the optical storage medium.

The method of the present invention embodied for reconnecting the interrupted data can be variant according to different optical storage mediums. If the optical storage medium is a rewritable disc, then the situation is much simpler and easier.

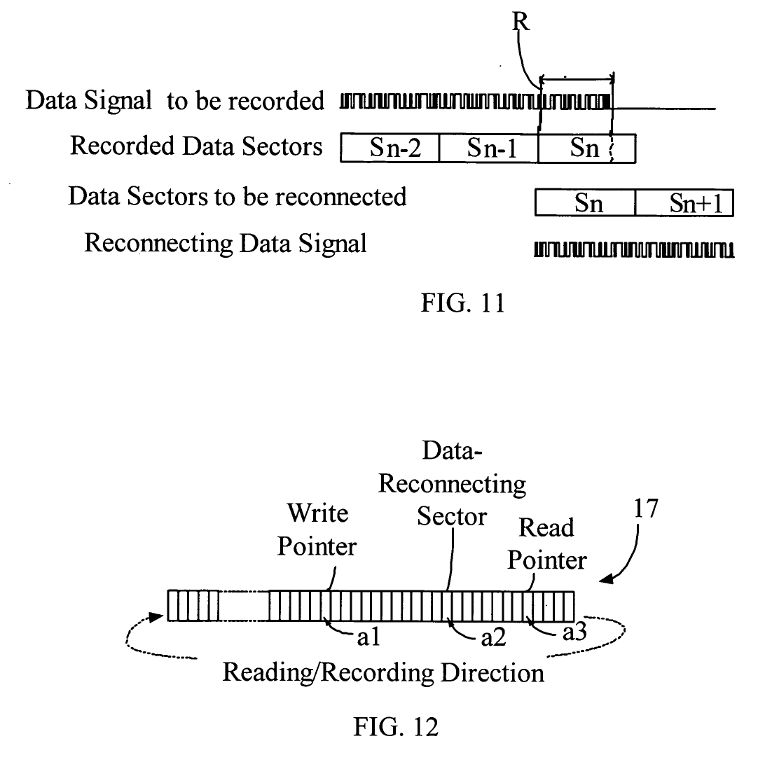

FIG. 11 is a schematic diagram for data reconnection while the optical storage medium is a rewritable disc. The recording interruption in FIG. 11 appears on the data sector (Sₙ). Because the optical storage medium is a rewritable disc, the data-reconnecting address generator 19 sets the data-reconnecting address (R) to be the data sector where the data-interrupted address is located at the starting address of the data sector (Sₙ), or sets it to be one of the several data sectors before the present data sector, such as the starting addresses of the data sectors (Sₙ₋₁, Sₙ₋₂). Then the data recording module 16 adjusts the data to be further recorded and reconnects the data in unit of sector from the starting address of the set data sector (Sₙ), which is the data-reconnecting address (R). In this embodiment, because the linking boundary of the data recorded before the recording is interrupted and the reconnected data is the boundary of each logical sector, thus the data continuity is better than the other embodiments wherein the linking boundary is inside an logical sector.

FIG. 12 is a schematic diagram adjusting the data to be further recorded according to the embodiment shown in FIG. 11. The buffer memory 17 of the data recording module 16 takes the form as a ring buffer. In FIG. 12, each grid of the buffer memory 17 corresponds to a data sector. The buffer memory 17 comprises a write-pointer and a read-pointer. The write-pointer indicates the address information of the buffer memory 17 where current data from the data source are stored. The read-pointer indicates the address information of the buffer memory 17 where the data to be recorded on the optical storage medium are read-out. During the recording process, along the arrow direction, the data from the data source are buffered into the buffer memory 17, and the data to be recorded are read-out from the buffer memory 17. In the buffer memory 17, new data from the data source will overwrite the memory region where the stored data has been read-out. The write-pointer and the read-pointer are kept larger than a predetermined distance to prevent the overwriting of the data that have not been read-out. The memory region between the write-pointer and the read-pointer represents that the data have been read-out, but have not yet been overwritten by the new data.

Please refer to FIG. 12. When data recording is interrupted, the data sector address indicated by the write-pointer is al, the data sector address in the buffer memory 17, which corresponds to the data-reconnecting address (R), is a2, and the data sector address indicated by the read-pointer is a3. In the embodiment in FIG. 10, the data recording module just needs to move the read-pointer to the data sector (a2) according to the data-reconnecting address, and then the data to be further recorded can then be read out from the data sector (a2), and be written into the optical storage medium.

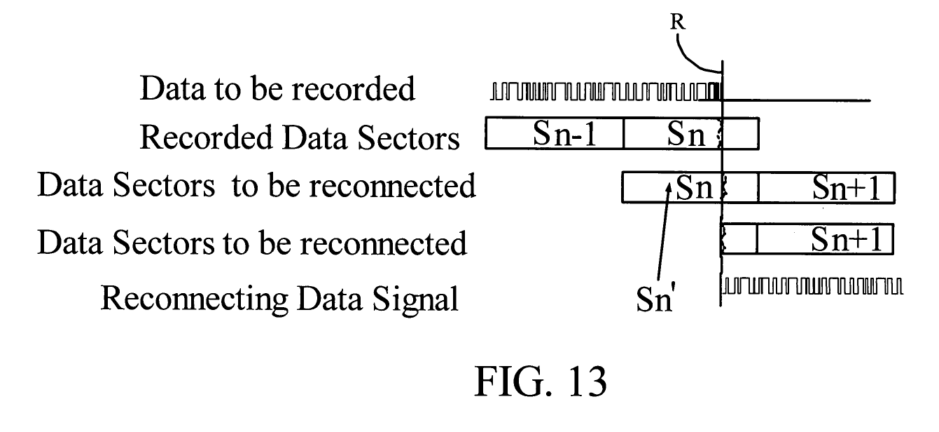

Please refer to FIG. 13. FIG. 13 is a schematic diagram for data reconnection while the optical storage medium is an un-rewritable disc. In FIG. 13, the data recording interruption can also appear in the data sector (Sₙ). Because the optical storage medium is un-rewritable, the data recording module 16 must base on the precise reference logical or physical address of the data-reconnecting address (R) to discard some data read from the buffer memory. That means the data recording module 16 must discard some data sector (Sₙ) to be the data for further being reconnected from the data-reconnecting address (R). According to another embodiment of the present invention, after moving the read-pointer, the data to be read-out for reconnecting is re-encoded, and the data to be recorded is then read out from the place the read-pointer points. Finally, the data recording module 16 discards some data according to the data-reconnecting address (R) to reconnect the data to be recorded from the data-reconnecting address (R).

By the proffered mechanism of adjusting the data which is to be further recorded, the present invention solves the problems in the prior arts, which include: due to the non-adjustment of the data to be further recorded, the problem relating to the difference between the appearance point of the recording-interrupted signal and the actual interrupted point of the recorded data can not be overcome in the prior art. Therefore, the present invention solves the problem in the prior arts that some data lose still occurs even if the data reconnection is performed.

The present invention provides an optical recording device for recording a plurality of data on an optical storage medium. When recording is interrupted, the interrupted data is reconnected according to a data-reconnecting address so as to enable further correct reading of the interrupted data. When the optical recording device detects that the data is interrupted when recording, the optical recording device sends out a recording-interrupted signal and stops recording the data on the optical storage medium. Then a data-reconnecting address is generated according to a data-interrupted address. The optical recording device adjusts the would-be-reconnected data to be the data corresponding to the data-reconnecting address, and takes the data-reconnecting address to be the starting address for reconnecting the data on the optical storage medium.

The optical recording device of the present invention solves the problems in the prior arts: errors occur when the interrupted data is reconnected. Because the optical recording device of the present invention can correctly reconnect the interrupted data on the optical recording medium, the present invention further reduces the rerecording time, and decreases the wasted cost of discs. Besides, the optical recording device of the present invention further improves the recording accuracy of the optical recording device, therefore the present invention makes the high-accuracy and high-speed optical recording device become possible.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical recording device for recording a plurality of data on an optical storage medium, the optical recording device comprising:
an addressing module providing a reference address on the optical storage medium;
a recording-interrupted generator detecting a recording-interrupted condition and generating a recording-interrupted signal;
a data-interrupted address generator generating a data-interrupted address;
a data-reconnecting address generator generating a data-reconnecting address according to the data-interrupted address; and
a data recording module recording the data on the optical storage medium, suspending recording the data on the optical storage medium according to the recording-interrupted signal, adjusting the data to be further recorded according to the data-reconnecting address, and reconnecting the data according to the data-reconnecting address and the reference address;
wherein, the data recording module adjusts the data to be further recorded according to the data-reconnecting address.

2. The optical recording device of claim 1, wherein the recording-interrupted condition is the condition resulting in erroneous recording of the recording device.

3. The optical recording device of claim 2, wherein the data recording module comprises a buffer memory for buffering the data from a data source.

4. The optical recording device of claim 3, wherein the recording-interrupted condition comprises that the amount of data, which is buffered in the buffer memory and is not recorded on the optical storage medium, is lower than a predetermined threshold value.

5. The optical recording device of claim 3, wherein the buffer memory comprises:
a write-pointer and a read-pointer indicating respectively the address of the buffer memory to read the data to be recorded and the address of the buffer memory to buffer the data from the data source, and the write-pointer and the read-pointer are kept with a distance larger than a predetermined threshold;
wherein the data recording module moving the read-pointer according to the data-reconnecting address.

6. The optical recording device of claim 5, wherein the data recording module discards some data read from the buffer memory according to the data-reconnecting address.

7. The optical recording device of claim 5, wherein some of the data that have been previously encoded are re-encoded after the read-pointer is moved.

8. The optical recording device of claim 1, wherein the addressing module provides a physical address pre-recorded on the optical storage medium as the reference address, and the addressing module comprises:
a wobble extractor generating a wobble signal according to a push-pull signal detected from the optical storage medium;
a phase-locked loop generating a clock signal synchronized with the wobble signal;
a physical address decoder decoding the physical address pre-recorded on the optical storage medium from the push-pull signal and generating a decoded physical address; and
a physical address counter being loaded with a value corresponding to the decoded physical address if the physical address is correctly decoded and counting according to the clock signal of the phase-locked loop to generate the reference address.

9. The optical recording device of claim 1, wherein the addressing module provides a physical address pre-recorded on the optical storage medium as the reference address, and the addressing module comprises:
a wobble extractor generating a wobble signal according to a push-pull signal detected from the optical storage medium;
a reference clock source providing a reference clock signal having a frequency higher than the wobble signal;
a wobble sync signal detector generating a wobble sync signal synchronizing with the wobble signal;
a physical address decoder decoding the physical address pre-recorded on the optical storage medium from the push-pull signal, and generating a decoded physical address; and
a physical address counter comprising at least a low-bit counter and a high-bit counter for generating the reference address, the physical address counter being loaded with a value corresponding to the decoded physical address if the physical address is correctly decoded, the low-bit counter counting according to the reference clock signal and being reset according to the wobble sync signal, and the high-bit counter counting according to the wobble sync signal.

10. The optical recording device of claim 9, wherein the wobble sync signal detector comprises a phase-locked loop for locking the wobble signal by adjusting the phase of an output signal in unit of one period of the reference clock signal.

11. The optical recording device of claim 1, wherein the addressing module provides a pre-recorded physical address on the optical storage medium as the reference address, and the addressing module comprises:
a physical address decoder decoding the physical address pre-recorded on the optical storage medium from a push-pull signal detected from the optical storage medium, and generating a decoded physical address;
a reference clock source providing a reference clock signal having a frequency higher than a wobble signal;
a physical address sync signal detector detecting a physical address sync signal pre-recorded on the optical storage medium from the push-pull signal, and generating a physical address sync reference signal; and
a physical address counter, comprising at least a low-bit counter and a high-bit counter for generating the reference address, the physical address counter being loaded with a value corresponding to the decoded physical address if the physical address is correctly decoded, the low-bit counter counting according to the reference clock signal and being reset according to the physical address sync signal, and the high-bit counter counting according to the physical address sync signal.

12. The optical recording device of claim 11, wherein the physical address sync signal detector comprises a phase-clocked loop for locking the physical address sync signal pre-recorded on the optical storage medium and adjusting the phase of an output signal in unit of one period of the reference clock signal.

13. The optical recording device of claim 1, wherein the addressing module provides a reference logical address of the recorded data on the optical storage medium as the reference address, and the addressing module comprises:
a logical sector address decoder decoding the logical sector address of the data recorded on the optical storage medium and generating a decoded logical sector address;
a logical address sync signal detector detecting a logical address sync signal of the data;
a reference clock source providing a reference clock signal; and
a logical address counter, comprising at least a low-bit counter and a sector counter for generating the reference address, the logical address counter being loaded with a value corresponding to the decoded logical sector address if the logical sector address is correctly decoded, the low-bit counter counting according to the reference clock signal and being reset according to the logical address sync signal, and the sector counter counting according to the logical address sync signal.

14. The optical recording device of claim 1, wherein the data-interrupted address generator comprises a storage device for storing an address corresponding to the interruption of the data recorded on the optical storage medium as the data-interrupted address.

15. The optical recording device of claim 14, wherein the data-interrupted address generator further comprises a length detector for receiving a channel bit signal detected from the optical storage medium and for enabling the storage device to store the data-interrupted address by detecting if the length of continuous channel bits with the identical signal state exceeds a predetermined length.

16. The optical recording device of claim 14, wherein the data-interrupted address generator further comprises a data reader for reading the data recorded on the optical storage medium and for enabling the storage device to store the data-interrupted address by detecting if the error amount of the read data is greater than a predetermined threshold value.

17. The optical recording device of claim 16, wherein the error amount is from an error detection code (EDC) corresponding to the data.

18. The optical recording device of claim 16, wherein the error amount is from an error correction code (ECC) corresponding to the data.

19. The optical recording device of claim 1, wherein the data-reconnecting address generator generates the data-reconnecting address by adding or subtracting an offset value to the data-interrupted address.

20. The optical recording device of claim 19, wherein the data-interrupted address is a data-interrupted logical address.

21. The optical recording device of claim 20, wherein the offset value comprises a difference between the logical address and the physical address.

22. The optical recording device of claim 21, wherein the data-reconnecting physical address generator comprises:
a physical address sync signal detector detecting a physical address sync signal pre-recorded on the optical storage medium from a push-pull signal, and generating a first sync signal;
a logical address sync signal detector detecting a logical address sync signal of the recorded data on the optical storage medium, and generating a second sync signal; and
a logical/physical address difference detector detecting a distance between the first sync signal and the second sync signal, and generating the difference between the logical address and the physical address.
